(19) United States
(12) Patent Application Publication
(10) Pub. No.: US 2026/0120506 A1
(43) Pub. Date: Apr. 30, 2026

(54) TRAINING AN ID INJECTION MODULE FOR GENERATING SYNTHESIZED IMAGES

(71) Applicant: Lemon Inc., Grand Cayman (KY)

(72) Inventors: Tiancheng ZHI, Los Angeles, CA (US); Shen SANG, Los Angeles, CA (US); Jing LIU, Los Angeles, CA (US); Linjie LUO, Los Angeles, CA (US)

(21) Appl. No.: 18/927,667

(22) Filed: Oct. 25, 2024

(51) Int. Cl. G06V 40/16; G06T 5/70

(52) U.S. Cl. CPC G06V 40/168; G06T 5/70

(57) ABSTRACT

A computing system receives an original image and a corresponding identification image, generates ID features based on the identification image, and generates a noisy image by applying a ground truth noise on the original image. The noisy image is denoised via the diffusion model with and without any injection of the ID features to generate second and first predicted noises, respectively. The system generates an ID mask and non-ID mask which identifies identity-related and identity-independent regions in the original image, respectively. An identity-independent loss is calculated based on the first and second predicted noises and the non-ID mask. An identity-preserved loss is calculated based on the ID mask, the second predicted noise, and the ground truth noise. A sum of the losses is used to train an ID injection module configured to inject ID features into the diffusion model for generating a synthesized image.

### BACKGROUND

Diffusion models are a class of probabilistic generative models that typically involve two stages: a forward diffusion stage and a reverse denoising stage. In the forward diffusion process, input data is gradually altered and degraded over multiple iterations by adding noise at different scales. In the reverse denoising process, the model learns to reverse the diffusion noising process, iteratively refining an initial image, typically made of random noise, into a fine-grained colorful synthesized image.

Recently, conventional diffusion models have been developed that take as input a text input, image input (e.g., pose image, background image, etc.), or other modes of input, and generate an output image based on the input(s). However, these conventional diffusion models face significant limitations, particularly when tasked with generating images of a known individual. For example, these models often fail to preserve fine-grained identity characteristics of the known individuals in the input images.

To address this challenge, ID injection modules have been introduced as a way to inject identity features from reference images of known individuals into the generative process of diffusion models. Diffusion models with ID injection modules have been applied to generate personalized avatars, facial images with added effects, stylized images of the person, etc. These ID injection modules extract identity-specific features from a reference identification image and inject them into the diffusion model at various stages, enabling the model to generate images that reflect the identity of a specific individual. While ID injection helps personalize synthesized images, existing training methods for these modules suffer from several drawbacks, including low aesthetic quality and style discrepancies.

### SUMMARY

In view of the above issues, a computing system is provided for training an ID injection module configured to inject ID features into a diffusion model for generating a synthesized image. The computing system includes a processing circuitry and memory storing instructions that, when executed, cause the processing circuitry to receive an original image and an identification image corresponding to the original image. The system generates ID features based on the identification image, the ID features representing distinguishing characteristics of a target individual. The system further generates a noisy image by applying a ground truth noise on the original image. The noisy image is denoised via the diffusion model without any injection of the ID features to generate a first predicted noise. The noisy image is denoised via the diffusion model while injecting the ID features into the diffusion model to generate a second predicted noise. The system generates an ID mask which identifies identity-related regions in the original image, and a non-ID mask which identifies identity-independent regions in the original image.

An identity-independent loss is calculated based on the first predicted noise, the second predicted noise, and the non-ID mask. An identity-preserved loss is calculated based on the ID mask, the second predicted noise, and the ground truth noise. A sum of the identity-independent loss and the identity-preserved loss is calculated as a combined loss, and the ID injection module is trained using the calculated combined loss.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a training computing system and an inference computing system according to an example of the present disclosure.

FIG. 2 illustrates a detailed schematic view of the inference computing system of FIG. 1.

FIG. 3 illustrates a detailed schematic view of the data distillation and model distillation module of the training computing system of FIG. 1.

FIG. 4 illustrates a detailed schematic view of the trained machine learning diffusion model of the inference computing system of FIG. 1.

FIG. 5 is a flowchart of a method for training an ID injection module of a machine learning diffusion model using data and model distillation according to an example embodiment of the present disclosure.

FIG. 6 shows an example computing environment of the present disclosure.

### DETAILED DESCRIPTION

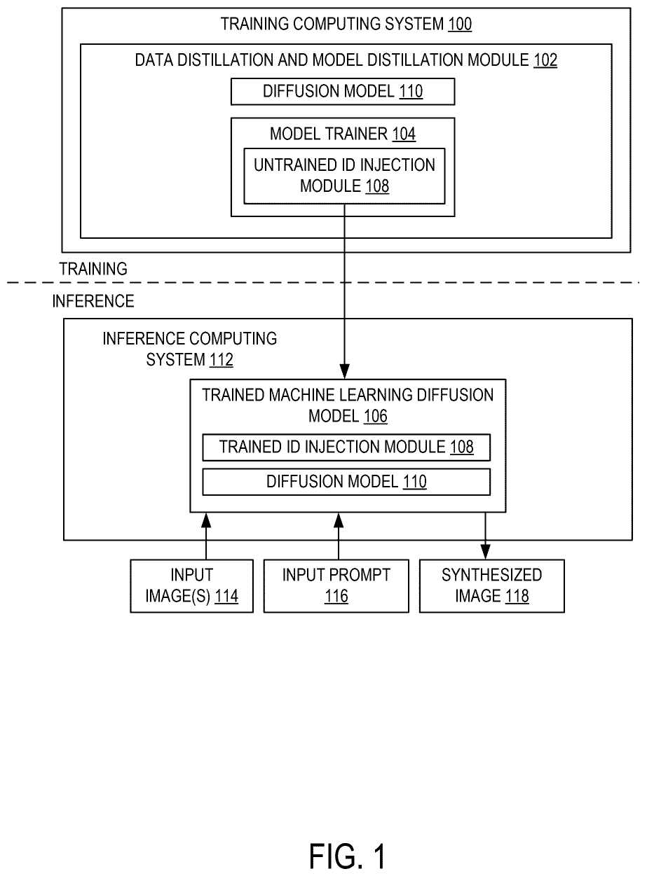

Referring to FIG. 1, a process of generating a synthesized image 118 using an ID injection and diffusion process is schematically depicted from the training steps to the inference steps. Initially, a training computing system 100 executes a data distillation and model distillation module 102, which includes a model trainer 104 configured to train an untrained ID injection module 108 using training data and a diffusion model 110. The ID injection module 108 trained by the model trainer 104 is then installed on an inference computing system 112 in a trained machine learning diffusion model 106 comprising a diffusion model 110, and used with the diffusion model 110 to receive one or more input images 114 and an input prompt 116. Responsive to receiving the one or more input images 114 and the input prompt 116, the trained machine learning diffusion model 106 processes the one or more input images 114 and the input prompt 116 to generate a synthesized image 118 with content corresponding to the one or more input images 114 and the input prompt 116, as explained in further detail below.

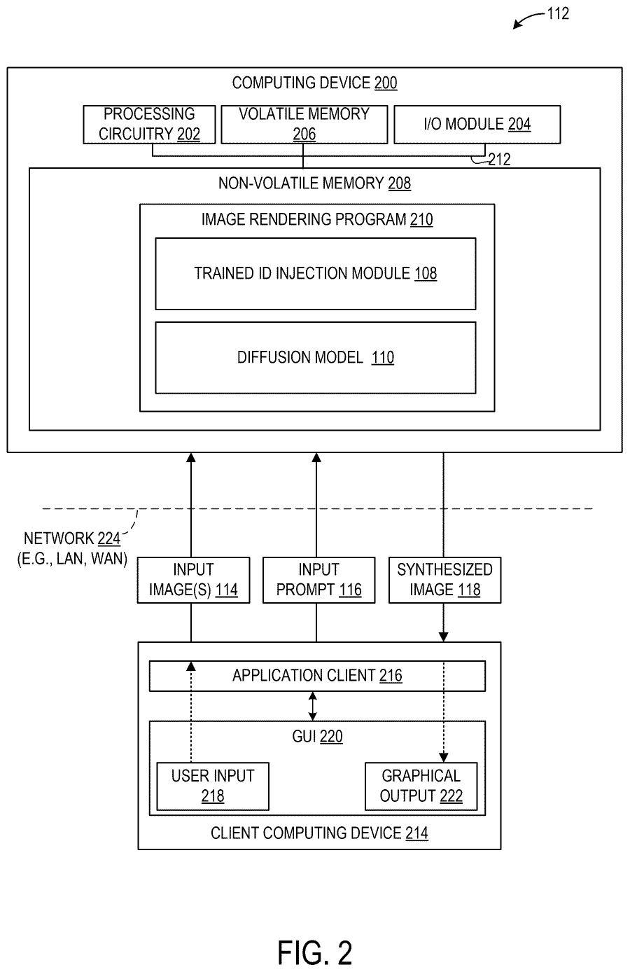

Referring to FIG. 2, an inference computing system 112 for generating a synthesized image using an ID injection and diffusion process is provided. The inference computing system 112 comprises a computing device 200 including processing circuitry 202, an input/output module 204, volatile memory 206, and non-volatile memory 208 storing an image rendering program 210 comprising a trained ID injection module 108 and a diffusion model 110. A bus 212 may operatively couple the processing circuitry 202, the input/output module 204, and the volatile memory 206 to the non-volatile memory 208. The inference computing system 112 is operatively coupled to a client computing device 214 via a network 224. In some examples, the network 224 may take the form of a local area network (LAN), wide area network (WAN), wired network, wireless network, personal area network, or a combination thereof, and can include the Internet. Although the image rendering program 210 is depicted as hosted at one computing device 200, it will be appreciated that the image rendering program 210 may alternatively be hosted across a plurality of computing devices to which the computing device 200 may be communicatively coupled via a network, including network 224.

The processing circuitry 202 is configured to store the image rendering program 210 in non-volatile memory 208 that retains instructions stored data even in the absence of externally applied power, such as FLASH memory, a hard disk, read only memory (ROM), electrically erasable programmable memory (EEPROM), etc. The instructions include one or more programs, including the image rendering program 210, and data used by such programs sufficient to perform the operations described herein. In response to execution by the processing circuitry 202, the instructions cause the processing circuitry 202 to execute the image rendering program 210, which includes the trained ID injection module 108 and the diffusion model 110.

The processing circuitry 202 is a microprocessor that includes one or more of a central processing unit (CPU), a graphical processing unit (GPU), an application specific integrated circuit (ASIC), a system on chip (SOC), a field-programmable gate array (FPGA), a logic circuit, or other suitable type of microprocessor configured to perform the functions recited herein. Volatile memory 206 can include physical devices such as random access memory (RAM), static random access memory (SRAM), dynamic random access memory (DRAM), etc., which temporarily stores data only for so long as power is applied during execution of programs. Non-volatile memory 208 can include physical devices that are removable and/or built in, such as optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology.

In one example, a user operating the client computing device 214 may send one or more input images 114 and an input prompt 116 to the computing device 200. The processing circuitry 202 of the computing device 200 is configured to receive the one or more input images 114 and the input prompt 116 from the user and execute the image rendering program 210 including the trained ID injection module 108 and the diffusion model 110 to generate a synthesized image 118 with content that corresponds to the one or more input images 114 and the input prompt 116. The processing circuitry 202 then returns the synthesized image 118 to the client computing device 214.

The client computing device 214 may execute an application client 216 to send the one or more input images 114 and the input prompt 116 to the computing device 200 upon detecting a user input 218 and subsequently receive the synthesized image 118 from the computing device 200. The application client 216 may be coupled to a graphical user interface 220 of the client computing device 214 to display a graphical output 222 of the synthesized image 118.

Although not depicted here, it will be appreciated that the training computing system 100 that executes the data distillation and model distillation module 102 of FIG. 1 can be configured similarly to computing device 200.

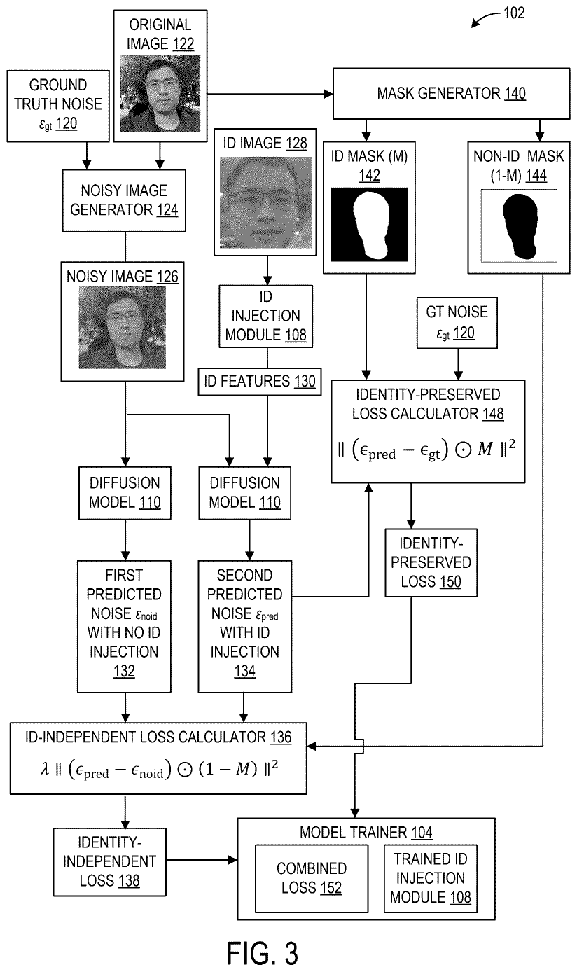

Referring to FIG. 3, operations of the data distillation and model distillation module 102 of FIG. 1 are described in detail in one example embodiment. An original image 122 and an identification image 128 from a training data set are received and used to train the ID injection module 108. In the example of FIG. 3, the original image 122 is a face of a target individual, and the identification image 128 is a cropped face of the same target individual in the original image 122, so that the identification image 128 corresponds to the original image 122. However, it will be appreciated that the original image 122 may alternatively take the form of other bodily features of the person, and the identification image 128 may alternatively take the form of other cropped bodily features of the person.

A noisy image generator 124 applies ground truth noise 120 to the original image 122 to generate a noisy image 126. In this example the original image 122 is that of a face of a person, and the noisy image 126 represents the same face but with noise applied to simulate various levels of degradation or distortion. This ground truth noise 120 could be in the form of random pixel perturbations, color shifts, or spatial disruptions, depending on the nature of the noise model used.

The noisy image 126 is subsequently passed through a diffusion model 110 to iteratively denoise the noisy image 126, progressively recovering the original image 122 or an approximation thereof through a series of reverse diffusion steps. In a first instance of the diffusion model 110, the noisy image 126 is denoised with injection of ID features 130 from the ID injection module 108, thereby generating a second predicted noise 134 with injection of ID features 130 from the ID injection module 108. In a second instance of the diffusion model 110, the noisy image 126 is denoised without any injection of ID features 130 from the ID injection module 108, thereby generating first predicted noise 132 with no injection of ID features 130 from the ID injection module 108. The first predicted noise 132 with no ID injection serves as a baseline to measure the influence of ID injection, while the second predicted noise 134 with ID injection is configured to retain identity information, such as facial features identified in the identification image 128, throughout the reverse diffusion process.

The identification image 128 is inputted into an ID injection module 108 to generate ID features 130 that are subsequently injected into the diffusion model 110. The ID features 130 represent distinguishing characteristics of a target individual. The ID injection module 108 may comprise a plurality of convolutional neural networks. For example, the ID injection module 108 may be configured as a ControlNet with an encoder which is a trainable copy of the encoder of the diffusion model 110. The attention layers of the encoder of the ControlNet may receive input of the identification image 128. Zero-initialized convolutional layers, which are 1×1 convolutional layers with both weights and biases introduced to zeros, may transform the features generated by the encoder before injection into the diffusion model 110 as ID features 130 or control signals of the ID injection module 108.

The mask generator 140 receives input of the original image 122 and generates a binary ID mask 142 (M) that identifies identity-related regions in the original image 122, which are facial features of a target individual in this example. A complementary non-ID mask 144 (1−M) is also generated to identify identity-independent regions, which are the non-facial features of the target individual in the original image 122. The mask generator 140 may execute feature detection algorithms to segment the original image 122 into distinct regions. Specifically, in this example, the mask generator 140 applies facial recognition techniques to identify key identity-related regions in the original image 122 such as the eyes, nose, mouth, and other distinguishing facial features. These regions are mapped into the binary ID mask 142 (M), where the pixel corresponding to these features are marked as ‘1’, while all the other areas are set to ‘0’. Concurrently, the mask generator 140 may generate the complementary non-ID mask 144 (1−M) by inverting the binary ID mask 142 (M), so that identity-related regions in the original image 122 are marked as ‘0’, while all the other areas are set to ‘1’.

The identity-preserved loss calculator 148 calculates an identity-preserved loss 150 based on the ground truth noise 120 (ε_{gt}), the ID mask 142 (M), and the second predicted noise 134 (ε_{pred}) with ID injection with the following identity-preserved loss function: ∥(ε_{pred}−ε_{gt})⊙M∥².

The identity-preserved loss calculator 148 calculates the difference between the second predicted noise 134 and the ground truth noise 120 to measure how well the diffusion model 110 with injection of ID features 130 approximates the true noise. This difference is element-wise multiplied by the ID mask 142 (M), thereby ensuring that only the regions corresponding to identity-related features (facial features in this example) are considered in the identity-preserved loss 150. Finally, the squared norm is applied to the result, resulting in the sum of squared differences of the masked difference values which is the calculated identity-preserved loss 150. This norm computes the squared magnitude of the difference values specifically in the identity-related regions.

The identity-independent loss calculator 136 calculates an identity-independent loss 138 based on the first predicted noise 132 (ε_{noid}) with no ID injection, the second predicted noise 134 (ε_{pred}) with ID injection, and the complementary non-ID mask 144 (1−M) with the following identity-independent loss function: λ∥(ϵ_{pred}−ϵ_{noid})(1−M)∥², where λ is a scalar value.

The identity-independent loss calculator 136 calculates the difference between the first predicted noise 132 and the second predicted noise 134. The first predicted noise 132 with no ID injection serves as a baseline to measure how much the ID injection affects the diffusion model 110 in areas that are not related to identity. This difference is element-wise multiplied by the complementary non-ID mask 144 (1−M), thereby ensuring that only the identity-independent regions (areas outside of the facial features in this example) are considered in the identity-independent loss 138. The squared norm is applied to the result, resulting in the sum of squared differences of the complementary non-ID masked difference values in the identity-independent regions. The result is multiplied by a scalar weight λ, which may be set to 0.1, for example. The scalar weight λ controls the influence of the identity-independent loss 138 relative to the identity-preserved loss 150, ensuring that the model trainer 104 trains the ID injection module 108 with the identity-preserved loss 150 to focus on identity-related regions.

The model trainer 104 sums the identity-preserved loss 150 and the identity-independent loss 138 to calculate the combined loss 152, which is used to update the model parameters of the ID injection module 108. The model trainer 104 iteratively adjusts the parameters of the ID injection module 108 through a backpropagation process using the combined loss 152 as the optimization target. The weights of the ID injection module 108 may be adjusted by optimizing the combined loss 152. The identity-preserved loss 150 in the combined loss 152 ensures that key identity-related regions are accurately maintained and reconstructed during the training process.

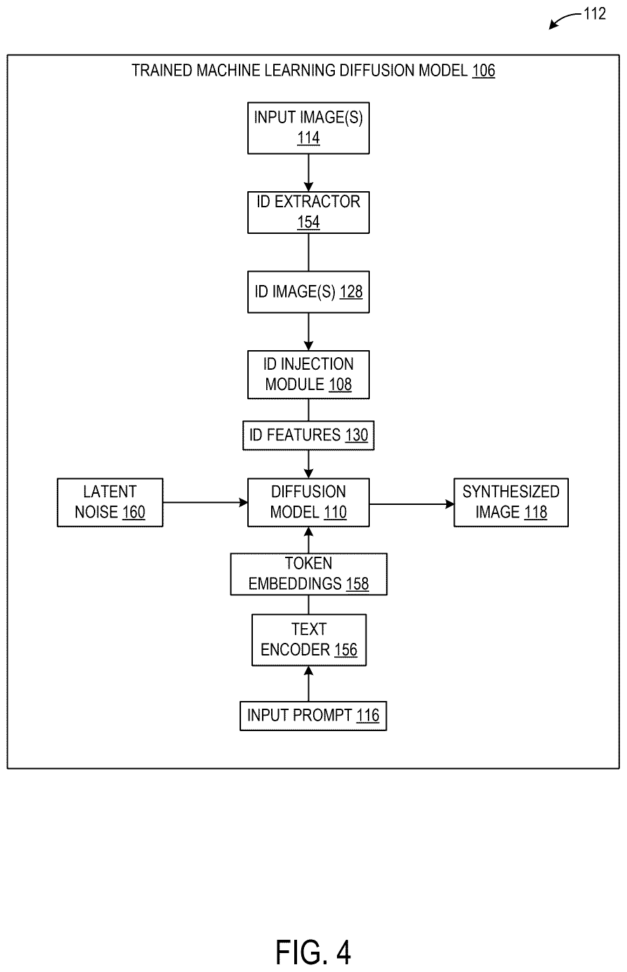

Referring to FIG. 4, operations of the trained machine learning diffusion model 106 of FIG. 1 are described in detail according to one example embodiment. One or more input images 114 are inputted into an ID extractor 154 to respectively extract one or more identification images 128 from the one or more input images 114. The identification images 128 are derived from the one or more input images 114 and may take the form of cropped bodily features of an individual identified in the one or more input images 114. For example, the identification images 128 may isolate and represent the face of an individual identified in the one or more input images 114. The one or more identification images 128 are inputted into the ID injection module 108 to extract ID features 130 of the one or more identification images 128. The ID features 130 are subsequently injected into the diffusion model 110.

Concurrently, the input prompt 116 is inputted into a text encoder 156 to extract token embeddings 158 of the input prompt 116. In other embodiments, the diffusion model 110 may be multi-modal and encoders for other modes of input may additionally or alternatively be included. These token embeddings 158, which capture the textual features of the input prompt 116, are subsequently injected into the diffusion model 110. The diffusion model 110 generates the synthesized image 118 from latent noise 160 through iterative denoising steps, in which the noise 160 is processed through a series of convolutional layers and attention mechanisms to progressively refine the image while receiving injections of the ID features 130 from the ID injection module 108 and token embeddings 158 from the text encoder 156.

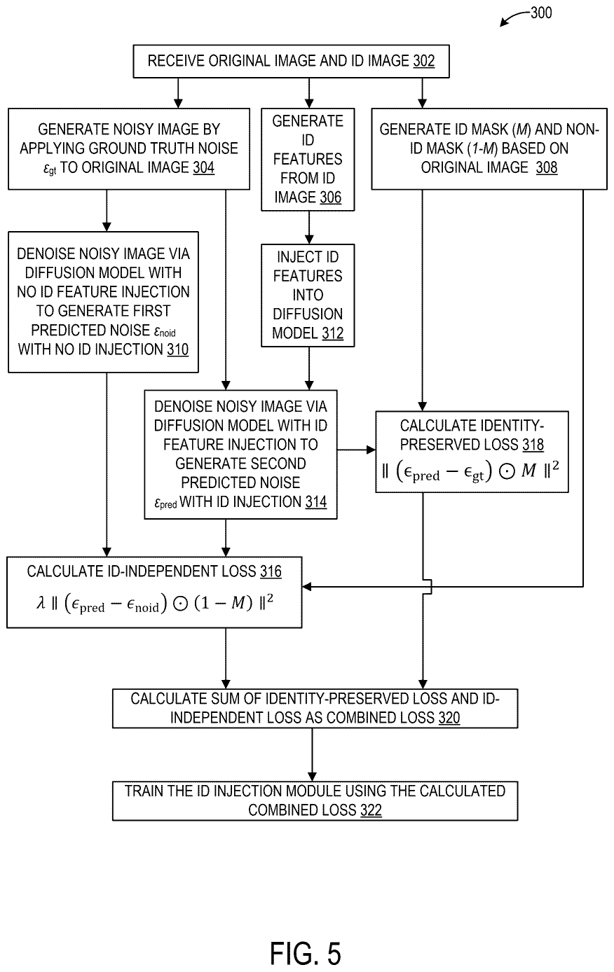

FIG. 5 shows a process flow diagram of an example method 300 for generating a synthesized image. The example method 300 may be executed by the processing circuitry and memory of the training computing system 100 of FIG. 1. The example method 300 includes, at step 302, receiving an original image and an identification image corresponding to the original image. At step 304, the method 300 includes generating a noisy image by applying ground truth noise to the original image. At step 306, the method 300 includes generating ID features from the identification image. At step 312, the method 300 includes injecting the ID features into the diffusion model.

At step 310, the method 300 includes denoising the noisy image via the diffusion model without any injection of ID features to generate a first predicted noise with no injection of ID features. At step 314, the method 300 includes denoising the noisy image via the diffusion model with injection of ID features to generate the second predicted noise with injection of ID features.

At step 308, the method 300 includes generating a binary ID mask that identifies identity-related regions in the original image, and a complementary non-ID mask that identifies identity-independent regions in the original image. At step 316, the identity-independent loss is calculated based on the first predicted noise (ε_{noid}), the second predicted noise (ε_{pred}), and the non-ID mask (1−M) with the following identity-independent loss function: λ∥(ϵ_{pred}−ϵ_{noid})⊙(1−M)∥², where λ is a scalar value. At step 318, the identity-preserved loss is calculated based on the ID mask (M), the second predicted noise (ε_{pred}), and the ground truth noise (ε_{gt}) with the following identity-preserved loss function: ∥(ϵ_{pred}−ϵ_{gt})⊙M∥². At step 320, the sum of the identity-preserved loss and the identity-independent loss is calculated as the combined loss. At step 322, the ID injection module is trained using the calculated combined loss. The parameters of the ID injection module are adjusted through a backpropagation process using the combined loss as the optimization target.

As described throughout herein, by training an ID injection module using a combined loss that includes both an identity-preservation loss and an identity-independent loss, images containing a target individual can be synthesized with a diffusion model receiving injections of ID features from the trained ID injection module to consistently maintain the identity of the target individual in the synthesized image while preserving aesthetic and stylistic consistency as well as minimizing artifacts and stylistic distortions.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

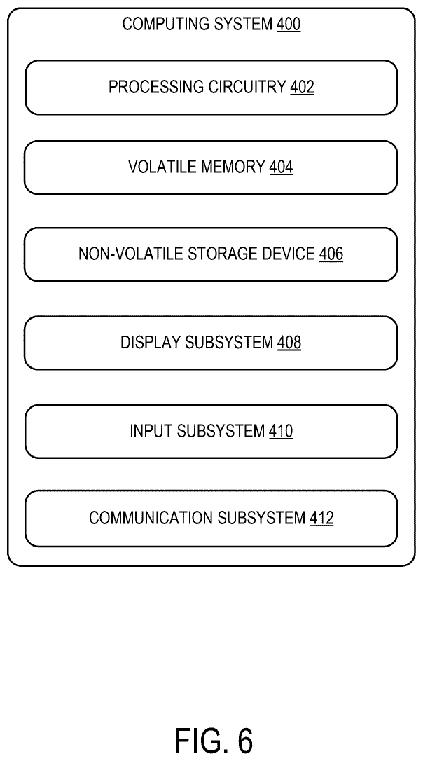

FIG. 6 schematically shows a non-limiting embodiment of a computing system 400 that can enact one or more of the methods and processes described above. Computing system 400 is shown in simplified form. Computing system 400 may embody the training computing system 100 described above and illustrated in FIG. 1 or the computing device 200 and client computing device 214 described above and illustrated in FIG. 2. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 6.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 402.

Non-volatile storage device 406 includes one or more physical devices configured to hold instructions executable by the processing circuitry 402 to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 400 to send and/or receive messages to and/or from other devices via a network such as the Internet.

The following paragraphs provide additional description of the subject matter of the present disclosure. One aspect provides for a computing system for training an ID injection module configured to inject ID features into a diffusion model for generating a synthesized image, the computing system comprising processing circuitry and memory storing instructions that, when executed, cause the processing circuitry to receive an original image and an identification image corresponding to the original image, generate ID features based on the identification image, the ID features representing distinguishing characteristics of a target individual, generate a noisy image by applying a ground truth noise on the original image, denoise the noisy image via the diffusion model without any injection of the ID features to generate a first predicted noise, denoise the noisy image via the diffusion model while injecting the ID features into the diffusion model to generate a second predicted noise, generate an ID mask which identifies identity-related regions in the original image, generate a non-ID mask which identifies identity-independent regions in the original image, calculate an identity-independent loss based on the first predicted noise, the second predicted noise, and the non-ID mask, calculate an identity-preserved loss based on the ID mask, the second predicted noise, and the ground truth noise, calculate a sum of the identity-independent loss and the identity-preserved loss as a combined loss, and train the ID injection module using the calculated combined loss. In this aspect, additionally or alternatively, the identity-preserved loss may be calculated based on the ID mask (M), the second predicted noise (ε_{pred}), and the ground truth noise (ε_{gt}) with the following identity-preserved loss function ∥(ϵ_{pred}−ϵ_{gt})⊙M∥². In this aspect, additionally or alternatively, the identity-independent loss may be calculated based on the first predicted noise (ε_{noid}), the second predicted noise (ε_{pred}), and the non-ID mask (1−M) with the following identity-independent loss function λ∥(ϵ_{pred}−ϵ_{noid})⊙(1−M)∥², where λ is a scalar value. In this aspect, additionally or alternatively, the original image may be a face of the target individual, and the identification image may be a cropped face of the target individual. In this aspect, additionally or alternatively, the ground truth noise may be random pixel perturbations. In this aspect, additionally or alternatively, the ID mask may be a binary mask which identifies facial features of the target individual in the original image, and the non-ID mask may identify non-facial features of the target individual in the original image.

Another aspect provides for a computing method for training an ID injection module configured to inject ID features into a diffusion model for generating a synthesized image, the computing method comprising receiving an original image and an identification image corresponding to the original image, generating ID features based on the identification image, the ID features representing distinguishing characteristics of a target individual, generating a noisy image by applying a ground truth noise on the original image, denoising the noisy image via the diffusion model without any injection of the ID features to generate a first predicted noise, denoising the noisy image via the diffusion model while injecting the ID features into the diffusion model to generate a second predicted noise, generating an ID mask which identifies identity-related regions in the original image, generating a non-ID mask which identifies identity-independent regions in the original image, calculating an identity-independent loss based on the first predicted noise, the second predicted noise, and the non-ID mask, calculating an identity-preserved loss based on the ID mask, the second predicted noise, and the ground truth noise, calculating a sum of the identity-independent loss and the identity-preserved loss as a combined loss, and training the ID injection module using the calculated combined loss. In this aspect, additionally or alternatively, the identity-preserved loss may be calculated based on the ID mask (M), the second predicted noise (ε_{pred}), and the ground truth noise (ε_{gt}) with the following identity-preserved loss function ∥(ϵ_{pred}−ϵ_{gt})⊙M∥². In this aspect, additionally or alternatively, the identity-independent loss may be calculated based on the first predicted noise (ε_{noid}), the second predicted noise (ε_{pred}), and the non-ID mask (1−M) with the following identity-independent loss function λ∥(ϵ_{pred}−ϵ_{noid})⊙(1−M)∥², where A is a scalar value. In this aspect, additionally or alternatively, the original image may be a face of the target individual, and the identification image may be a cropped face of the target individual. In this aspect, additionally or alternatively, the ground truth noise may be random pixel perturbations. In this aspect, additionally or alternatively, the ID mask may be a binary mask which identifies facial features of the target individual in the original image, and the non-ID mask may identify non-facial features of the target individual in the original image.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for training an ID injection module configured to inject ID features into a diffusion model for generating a synthesized image, the computing system comprising:
processing circuitry and memory storing instructions that, when executed, cause the processing circuitry to:
receive an original image and an identification image corresponding to the original image;
generate ID features based on the identification image, the ID features representing distinguishing characteristics of a target individual;
generate a noisy image by applying a ground truth noise on the original image;
denoise the noisy image via the diffusion model without any injection of the ID features to generate a first predicted noise;
denoise the noisy image via the diffusion model while injecting the ID features into the diffusion model to generate a second predicted noise;
generate an ID mask which identifies identity-related regions in the original image;
generate a non-ID mask which identifies identity-independent regions in the original image;
calculate an identity-independent loss based on the first predicted noise, the second predicted noise, and the non-ID mask;
calculate an identity-preserved loss based on the ID mask, the second predicted noise, and the ground truth noise;
calculate a sum of the identity-independent loss and the identity-preserved loss as a combined loss; and
train the ID injection module using the calculated combined loss.

2. The computing system of claim 1, wherein the identity-preserved loss is calculated based on the ID mask (M), the second predicted noise (ε_{pred}), and the ground truth noise (ε_{gt}) with the following identity-preserved loss function: ∥(ϵ_{pred}−ϵ_{gt})⊙M∥².

3. The computing system of claim 1, wherein the identity-independent loss is calculated based on the first predicted noise (ε_{noid}), the second predicted noise (ε_{pred}), and the non-ID mask (1−M) with the following identity-independent loss function: λ∥(ϵ_{pred}−ϵ_{noid})⊙(1−M)∥², where λ is a scalar value.

4. The computing system of claim 1, wherein the original image is a face of the target individual, and the identification image is a cropped face of the target individual.

5. The computing system of claim 1, wherein the ground truth noise is random pixel perturbations.

6. The computing system of claim 1, wherein
the ID mask is a binary mask which identifies facial features of the target individual in the original image; and
the non-ID mask identifies non-facial features of the target individual in the original image.

7. A computing method for training an ID injection module configured to inject ID features into a diffusion model for generating a synthesized image, the computing method comprising:
receiving an original image and an identification image corresponding to the original image;
generating ID features based on the identification image, the ID features representing distinguishing characteristics of a target individual;
generating a noisy image by applying a ground truth noise on the original image;
denoising the noisy image via the diffusion model without any injection of the ID features to generate a first predicted noise;
denoising the noisy image via the diffusion model while injecting the ID features into the diffusion model to generate a second predicted noise;
generating an ID mask which identifies identity-related regions in the original image;
generating a non-ID mask which identifies identity-independent regions in the original image;
calculating an identity-independent loss based on the first predicted noise, the second predicted noise, and the non-ID mask;
calculating an identity-preserved loss based on the ID mask, the second predicted noise, and the ground truth noise;
calculating a sum of the identity-independent loss and the identity-preserved loss as a combined loss; and
training the ID injection module using the calculated combined loss.

8. The computing method of claim 7, wherein the identity-preserved loss is calculated based on the ID mask (M), the second predicted noise (ε_{pred}), and the ground truth noise (ε_{gt}) with the following identity-preserved loss function: ∥(ϵ_{pred}−ϵ_{gt})⊙M∥².

9. The computing method of claim 7, wherein the identity-independent loss is calculated based on the first predicted noise (ε_{noid}), the second predicted noise (ε_{pred}), and the non-ID mask (1−M) with the following identity-independent loss function: λ∥(ϵ_{pred}−ϵ_{noid})⊙(1−M)∥², where λ is a scalar value.

10. The computing method of claim 7, wherein the original image is a face of the target individual, and the identification image is a cropped face of the target individual.

11. The computing method of claim 7, wherein the ground truth noise is random pixel perturbations.

12. The computing method of claim 7, wherein
the ID mask is a binary mask which identifies facial features of the target individual in the original image; and
the non-ID mask identifies non-facial features of the target individual in the original image.
